(19) United States
(12) Patent Application Publication
(10) Pub. No.: US 2008/0164668 A1
(43) Pub. Date: Jul. 10, 2008

(54) Boltless Wheelbarrow Bumper

(76) Inventor: William Kurt Feick, New Canaan, CT (US)

Correspondence Address: ST. ONGE STEWARD JOHNSTON & REENS, LLC, 986 BEDFORD STREET, STAMFORD, CT, 06905-5619, US

(21) Appl. No.: 11/621,802

(22) Filed: Jan. 10, 2007

(51) Int. Cl. B62B 1/00

(52) U.S. Cl. 280/47.31

(57) ABSTRACT

A wheelbarrow bumper for a wheelbarrow that has a bumper plate that spans distal ends of a plurality of wheelbarrow handles and a plurality of sleeves that extend in a direction relative to the bumper plate such that the sleeves comprise an angle of orientation that is non-perpendicular relative to the bumper plate. Upon alignment of the plurality of wheelbarrow handles with a corresponding sleeve and coupling of the plurality of wheelbarrow handles to at least one other wheelbarrow element, such as a wheelbarrow stand, tub, or tire, the plurality of sleeves are inhibited from moving in a proximal or distal direction relative to the wheelbarrow.

### FIELD OF THE INVENTION

This invention relates to wheelbarrow bumpers, more particularly to wheelbarrow bumpers that are secured to wheelbarrows without a bolt.

### BACKGROUND OF THE INVENTION

Wheelbarrows come in numerous designs based on different objectives. Some wheelbarrow designs are directed towards improving the ruggedness of the wheelbarrow. Other designs are directed towards improving the flexibility in storing a wheelbarrow. Still other designs are directed towards reducing the cost of manufacturing and assembling a wheelbarrow.

A wheelbarrow can comprise components such as a tub, stand, handles, a tire and a bumper. The bumper is typically secured to the front end of the handles and holds them together. The bumper is used as a footing for the wheelbarrow when it is emptied by lifting up the handles until the bumper is placed on the ground, and then pivoting the wheelbarrow further forward to dump out its contents. The bumper also is used to protect the tire while the wheelbarrow is moving in a forward direction. The bumper prohibits objects from being lodged in the regions between the wheel and the handles. In addition, the bumper helps prevent deformation of the end of the handle by absorbing impacts during dumping or when the wheelbarrow is off loaded to the ground from trucks during transportation between job sites. Often times bumpers and handles are damaged during this process.

In order to assure that the bumper is sufficiently secured to the wheelbarrow, it is typical to use bolts that pass through the bumper and into the handle. These bolts are typically inserted through the bumper and the handles and secured with nuts and washers. Such a bumper requires time to align holes in the bumper with holes in the handles and to securely fasten the handles and bumper with bolts and washers.

What is needed is a new wheelbarrow bumper design that furthers the objective of streamlining the assembly of a wheelbarrow, reduces the handling of fasteners, minimizes the chance for incorrect assembly, and reduces the cost of a wheelbarrow. It would be beneficial if such objectives are furthered through improvements of the design of a wheelbarrow bumper. It is also beneficial if such an improved wheelbarrow bumper could achieve such objectives and maintain the ruggedness of the wheelbarrow by preventing damage to the handle and bumper.

### SUMMARY OF THE INVENTION

These objectives are achieved by a wheelbarrow bumper for a wheelbarrow with a bumper plate that spans distal ends of a plurality of wheelbarrow handles and a plurality of sleeves, each comprising a cavity for receipt of a distal end of a wheelbarrow handle, that are coupled to the bumper plate. The plurality of sleeves extend in a direction relative to the bumper plate such that the sleeves comprise an angle of orientation that is non-perpendicular relative to the bumper plate, and such that upon insertion of the plurality of wheelbarrow handles into a corresponding sleeve and coupling of the plurality of wheelbarrow handles to at least one other wheelbarrow element, such as a wheelbarrow stand, tub, or tire, the plurality of sleeves are inhibited from moving in a proximal or distal direction relative to the wheelbarrow.

It is another aspect for the plurality of sleeves that extend away from the bumper plate to be divergent.

It is yet another aspect for the wheel barrow bumper to comprise left and right sleeves and upon insertion of a left wheelbarrow handle into the left sleeve and a right wheelbarrow handle into the right sleeve and upon coupling the wheelbarrow handles to at least one other wheelbarrow element, the inner walls of the sleeves inhibit the wheelbarrow bumper from moving in the distal direction or the outer walls of the sleeves inhibit the wheelbarrow bumper from moving in the proximal direction.

It is also an aspect for a gap to be disposed between a portion of a sleeve that is disposed about an inner face of the bumper plate and for a wedge to be placed in the gap to absorb the impact of a handle disposed in the sleeve against the bumper plate.

It is a further aspect for the bumper plate to comprise tabs that divergently extend from the bumper plate towards the proximal direction of a wheelbarrow and for the sleeves to be coupled to the tabs.

It is yet another aspect for a sleeve to comprise a locking indicator for whether the handle is sufficiently inserted into the sleeve. The indicator may include a hole that is formed on a surface of the sleeve and that receives a spring loaded pin that is coupled to the distal end of a wheelbarrow handle.

It is still a further aspect of the invention for the wheelbarrow bumper to be able to support the distal ends of the wheelbarrow handles so as to reduce deformation of the wheelbarrow handles due to dumping a wheelbarrow load.

These objectives are achieved by a wheelbarrow bumper for a wheelbarrow with a bumper plate that spans distal ends of a plurality of wheelbarrow handles and a plurality of sleeves each extending in a direction relative to the bumper plate such that each sleeve comprises an angle of orientation that is non-perpendicular relative to the bumper plate and comprises at least one coupling surface that is parallel to each respective direction of extension and comes into contact with at least one corresponding surface of each corresponding distal end of the plurality of wheelbarrow handles. Upon contacting each coupling surface with the corresponding surface of the plurality of wheelbarrow handles, and coupling of the plurality of wheelbarrow handles to at least one other wheelbarrow element, such as a wheelbarrow stand, tub, or tire, the plurality of sleeves are inhibited from moving in a proximal or distal direction relative to the wheelbarrow.

It is another aspect of the invention for each of the distal ends of the wheelbarrow handles to comprise a cavity for receipt of a sleeve. Each coupling surface is contacted with the corresponding surface of the plurality of wheelbarrow handles upon insertion of the plurality of sleeves into a corresponding wheelbarrow handle. Each coupling surface is an outer surface of each respective sleeve that contacts a corresponding inner surface of a wheelbarrow handle. The plurality of sleeves each comprises at least two walls that come into contact with at least two inner surfaces of a respective wheelbarrow handle. The inner surfaces of the wheelbarrow handles form the cavities of the wheelbarrow handles.

It is still another aspect of the invention for the wheelbarrow handle to comprise an indicator for whether the sleeve is sufficiently inserted into the handle. The indicator is a hole that extends from an outer surface of the handle to an inner surface of the handle and that is sized to receive a spring loaded pin coupled to the contact surface of the sleeve.

It is yet another aspect of the invention for the plurality of sleeves to comprise a cavity for receipt of a distal end of a wheelbarrow handle. Each coupling surface is contacted with the corresponding surface of the plurality of wheelbarrow handles upon insertion of the plurality of wheelbarrow handles into a corresponding sleeve.

Other aspects of the invention and its particular features and advantages will become more apparent from consideration of the following drawings and accompanying detailed description.

### BRIEF DESCRIPTION OF THE DRAWINGS

FIG. 1 is a perspective view of an assembled wheelbarrow.

FIG. 2A is a perspective view of a bumper plate with tabs.

FIG. 2B is an exploded perspective view of a bumper plate and sleeves.

FIG. 2C is a perspective view of a wheelbarrow bumper with sleeves coupled to a bumper plate.

FIG. 3A is a top plan view of the wheelbarrow bumper of FIG. 2C with the distal end of wheelbarrow handles in shadow.

FIG. 3B is a rear elevation view of the wheelbarrow bumper of FIG. 3A.

FIG. 4A is a cross-sectional view of the wheelbarrow bumper of FIG. 3A approaching the distal end of wheelbarrow handles.

FIG. 4B is a cross-sectional view of the wheelbarrow bumper of FIG. 4A receiving the distal end of wheelbarrow handles.

FIG. 4C is a cross-sectional view of the wheelbarrow handles of FIG. 4B completely inserted into the sleeve of the wheelbarrow bumper.

FIG. 4D is a perspective view of the wheelbarrow bumper of FIG. 3A aligned with the distal end of wheelbarrow handles.

FIG. 5A is a perspective view of wedges insertable into the gaps of the wheelbarrow bumper of FIG. 3A.

FIG. 5B is a top plan view of the wheelbarrow bumper of FIG. 3A with the wedges of FIG. 5A disposed in the gaps of the wheelbarrow bumper.

### DETAILED DESCRIPTION OF THE INVENTION

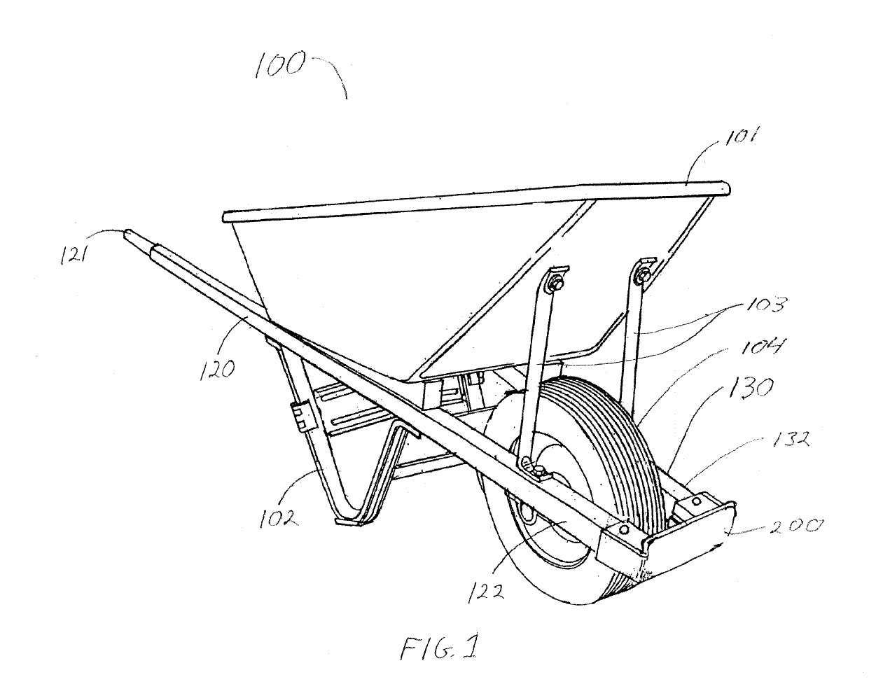

FIG. 1 depicts an assembled wheelbarrow 100. The wheelbarrow 100 comprises a tub 101, a stand 102, stays 103, tire 104, handles 120, 130 and bumper 200. Handles 120, 130 have proximal ends 121, 131 and distal ends 122, 132, to which the different components are mounted. The tub 101 and stand 102 are mounted to handles 120, 130 about the mid point of the handles 120, 130. The tub 101 is mounted above stand 102. Tub 101 is further coupled and supported by handles 120, 130 via stays 103. Stays 103 and wheel 104 are mounted to handles 120, 130 towards the distal ends 122, 132 of handles 120, 130. Handles 120, 130 are mounted to stand 102 such that the handles 120, 130 are not parallel. As a result, the spacing of handles 120, 130 at the proximal end of the wheel barrow is greater than the spacing of handles 120, 130 at the distal end. The proximal ends 121, 131 serve as the location in which an operator utilizes the wheelbarrow. The operator engages hand grips formed at the proximal ends 121, 131 and maneuvers the wheelbarrow 100. Further, at the distal ends 122, 132 a bumper 200 is mounted to handles 120, 130. Bumper 200 is shown to be mounted at the ultimate distal end of handles 120, 130, beyond wheel 104. Bumper 200 is also shown to have a length that corresponds to the spacing between the distal ends 122, 132 of the handles 120, 130.

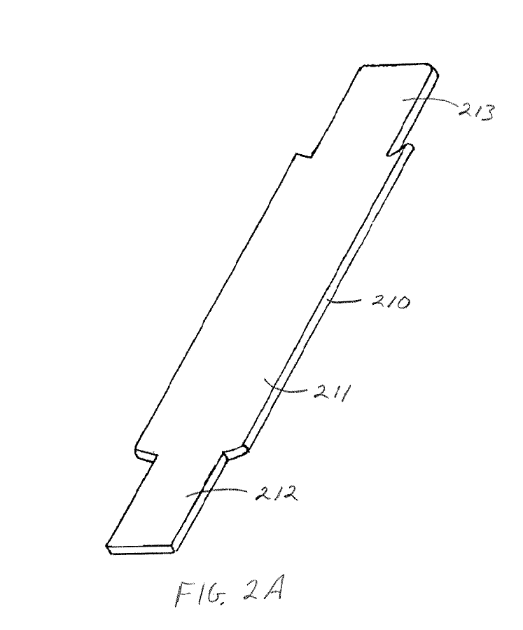

FIGS. 2A-C display the components that comprise wheelbarrow bumper 200. Wheelbarrow bumper 200 comprises a bumper plate 210, a right sleeve 220, and a left sleeve 230. Bumper plate 210 has a body 211, right tab 212 and left tab 213. The body 211, right tab 212, and left tab 213 are stamped as an integral part. Right 212 and left 213 tabs are bent towards the proximal end of wheelbarrow 100 and are oriented outwardly relative to body 211, i.e. the tabs 212, 213 diverge away from each other as they extend away from body 211.

The right 220 and left 230 sleeves are coupled to the inner faces of right 212 and left 213 tabs respectively. As a result sleeves 220, 230 extend from body 211 in the proximal direction of wheelbarrow 100. Sleeves 220, 230 are rectangular structures with outer walls 221, 231, upper walls 222, 232, lower walls 223, 233, and inner walls 224, 234. The cross section of sleeves 220, 230 is square. The outer walls 221, 231 are coupled to the inner faces of the tabs 212, 213. The sleeves 220, 230 can be coupled to the tabs 212, 213 by means such as welding, mechanical fastening, or bending of metal from a preformed sheet. Alternatively, tabs 212, 213 could form the outer walls of sleeves 220, 230 such that lower walls 223, 233 and inner walls 224, 234 are directly coupled to tabs 212, 213. The coupling of sleeves 220, 230 to tabs 212, 213 is also done in a manner such that a gap 227, 237 is formed between each sleeve 220, 230 and the body 211. This is achieved by sleeves 220, 230 being oriented outwardly relative to body 211. As a result acute angles 227A and 237A form between sleeves 220 and 230 and body 211. Outer walls 221, 231 can be characterized by slits 225, 235 that bifurcate the outer walls 221, 231 into two sections over the length of the walls 221, 231 from a proximal direct to a distal direction. The upper walls 222, 232 can be characterized by alignment holes 226, 236. The benefit of gaps 227, 237, slits 225, 235 and holes 226, 236 will be discussed in more detail below.

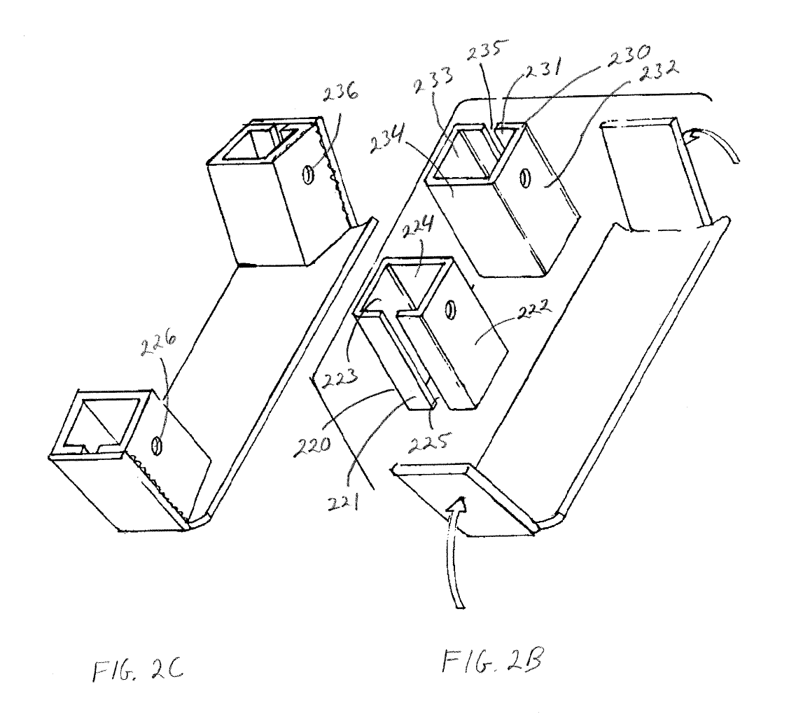

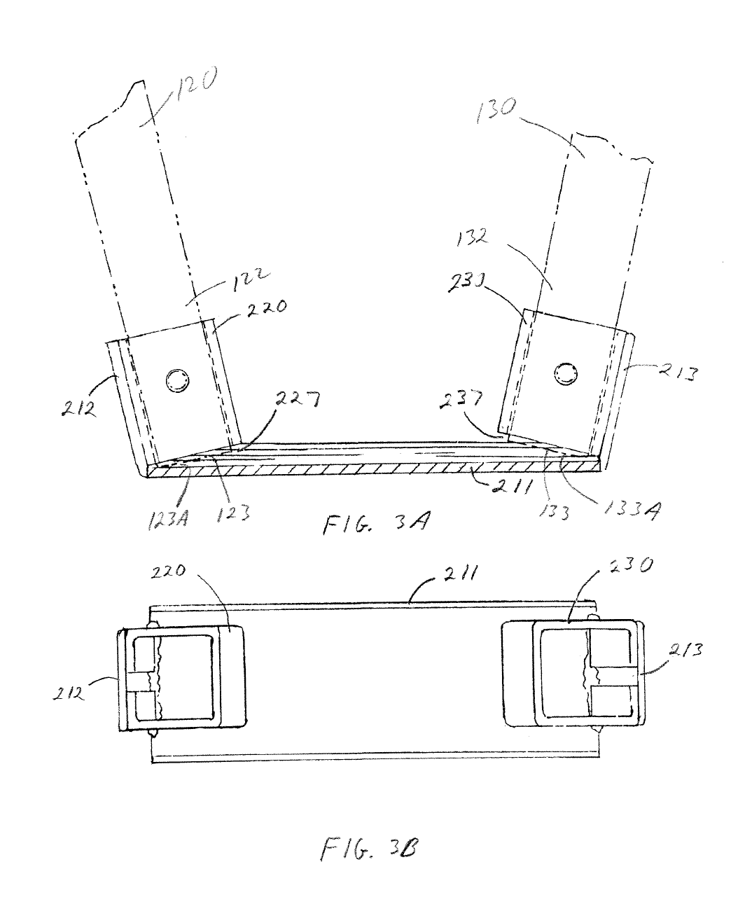

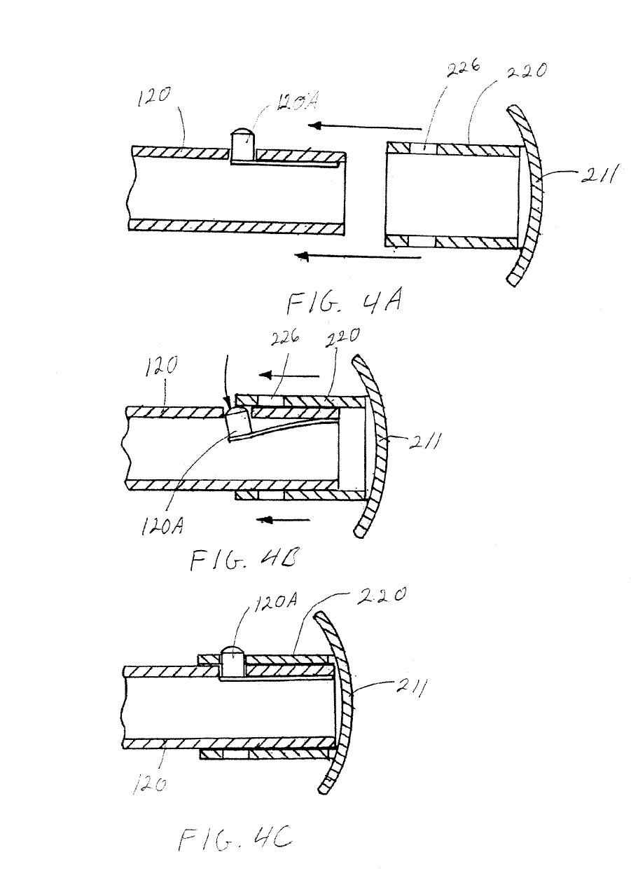

Sleeves 220, 230 are designed such that they are capable of mating with the distal ends of handles 120, 130. FIGS. 3A and 4A-D show that handles 120, 130 have an outer cross-sectional area that corresponds to the inner cross-sectional area of sleeves 220, 230. The outer cross-sectional area of handles 120, 130 can be less than or equal to the inner cross-sectional area of sleeves 220, 230. Further, the center-point displacement of handles 120, 130, i.e. the spacing, is such that the sleeves 220, 230 are able to align with handles 120, 130 and have the distal ends of handles 120, 130 inserted into the box like cavity formed by sleeves 220, 230. As noted before, handles 120, 130 are not parallel to each other. In order for bumper 200 to be attached to handles 120, 130, the handles must be inserted into sleeves 220, 230 prior to the handles being coupled to the remaining elements of wheelbarrow 100 such as tub 101 and stand 102. FIGS. 1 and 3A show that when handles 120, 130 are inserted into sleeves 220, 230 and subsequently coupled to stand 102. As a result each handle is parallel to the respective sleeve yet oriented outwardly, relative to body 211. The inner spacing of the sleeves and handles relative to one another increases from body 211 and extending towards the proximal direction. The orientation of the handles and sleeves relative to one another and to body 211 prevents bumper 200 from moving in both the proximal and distal directions. The inner faces of inner walls 224, 234 acting upon the corresponding outer surface of handles 120, 130 respectively prevent the bumper from sliding in the distal direction. The inner faces of outer walls 221, 231 acting upon the corresponding outer surface of handles 120, 130 respectively prevent the bumper from sliding in the proximal direction. This assists bumper 200 in being secured to wheelbarrow 100.

The ability to sufficiently couple sleeves 220, 230 to handles 120, 130 depends not only on the relative angle of these elements but also on the existence of sufficient contact areas between the elements. As a result the length of sleeves 220, 230 must be sufficient to provide suitable contact areas for the handles 120, 130 to act upon.

Further, it is important to assure that the handles are sufficiently inserted into sleeves 220, 230. FIGS. 4A-D show that the distal end of handle 120 incorporates a spring loaded pin 120A that is positioned on handle 120 to mate with hole 226 of sleeve 220. As the distal end of handle 120 is inserted into sleeve 220, the pin 120A comes into contact with upper wall 222. This causes pin 120A to regress into handle 120. As the handle 120 continues to be inserted, the pin 120A remains regressed until hole 226 is aligned over pin 120A. The spring loading of pin 120A causes pin 120A to extend through hole 226. This indicates that the handle 120 is sufficiently inserted into the sleeve 220 and also serves to prevent movement or sliding of the bumper 200 relative to the handles 120, 130. In order to assure that an assembler gets a proper indication that the sleeve is sufficiently inserted, it is beneficial if hole 226 is over sized relative to the diameter of pin 120A, i.e. has an inner diameter that is substantially greater than the outer diameter of pin 120A. This helps prevent the assembler from to continuously search for the proper alignment of hole 226 to pin 120A.

The ability of sleeves 220, 230 to be aligned with and secured to handles 120, 130 is assisted by the presence of slits 225, 235 and gaps 227, 237. When the wheelbarrow is assembled, the alignment of the sleeves 220, 230 may not be as originally intended. This may due to variations in the orientation of sleeves 220, 230 relative to the mounted orientation of handles 120, 130 on stand 102. Further, the manufacturing of bumper 200 may result in sleeves 220, 230 not being properly oriented. The presence of slits 225, 235 and gaps 227, 237 enable the orientation of the sleeves 220, 230 to be manipulated during the assembly of wheelbarrow 100. This enables sleeves 220, 230 and handles 120, 130 to be properly aligned with stand 102 and the other wheelbarrow elements. However, it is also important for sleeves 220, 230 to maintain sufficient contact area with handles 120, 130. As a result, it is necessary for slits 225, 235 and gaps 227, 237 only to be large enough to promote the manipulation of sleeves 220, 230 without sacrificing contact area available on walls such as inner walls 224, 234.

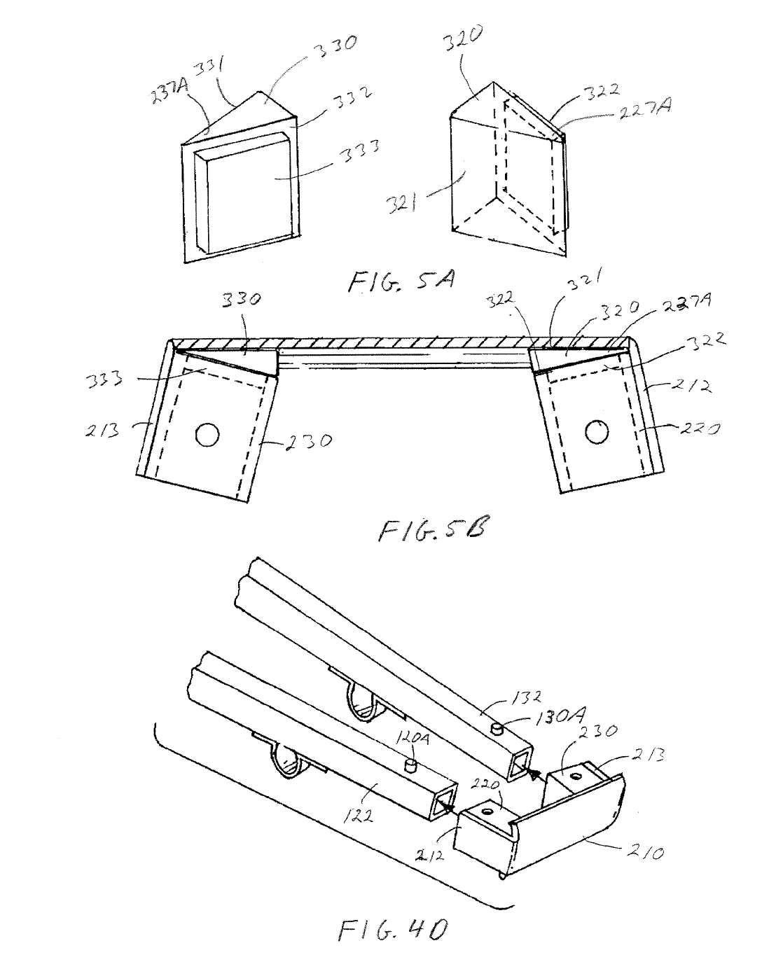

FIG. 3A illustrates that since acute angles 123A, 133A are formed by sleeves 220, 230 these angles also correspond to the angle of orientation of the ultimate distal surfaces 123, 133 of handles 120, 130 relative to body 211. Thus, if bumper 200 were to be subject to impact and handles 120, 130 were to subsequently come into contact with body 211, only the outer portions of distal surfaces 123, 133 would come into contact with body 211. This means that the force of handles 120, 130 on body 211 would be focused in those regions. This could cause damage to the handles and to the bumper, especially if the bumper were to be made of a hard plastic. FIGS. 5A and 5B show that in order to distribute the forces due to impact, it is beneficial to incorporate wedges 320 and 330. These wedges 320, 330 are inserted into gaps 227, 237 respectively. Wedges 320, 330 have bumper body faces 321, 331 that come into flush contact with the proximal oriented face of body 211. Wedges 320, 330 also have sleeve faces 322, 332 that come into flush contact with sleeves 220, 230 respectively. As a result, the orientation of bumper body faces 321, 331 relative to sleeve faces 322, 332 are characterized by acute angles 227A and 237A. Wedges 320, 330 are further characterized by handle impact surfaces 323, 333. Handle impact surfaces 323, 333 are disposed on sleeve faces 322, 332. Like sleeves 220, 320, handle impact surfaces 323, 333 have a square cross section and an outer cross-sectional area that corresponds to the inner cross-sectional area of sleeves 220, 230. Thus, when wedges 320, 330 are disposed between the bumper body 211 and the sleeves 220, 230, the impact surfaces 323, 333 extend into the inner cavities of the sleeves 220, 230. The impact surfaces 323, 333 interact with the ultimate distal surfaces 123, 133 of handles 120, 130 to provide a flush surface that receives the forces exerted by handles 120, 130. These forces are subsequently distributed over a greater area of bumper body 211. As a result, wedges 320, 330 help protect both handles 120, 130 and bumper 200. Since the wedges are receiving and distributing impact forces it is beneficial if the wedges are constructed of a non-ridged or malleable material such as plastic. Further, wedges 320, 330 can be independent elements that are inserted between sleeves 220, 230 and body 211 or can be coupled to bumper 200, such as being of unibody construction or welded to body 211. If bumper 200 is constructed utilizing a hard plastic, the wedges 320, 330 can be formed as a part of the mold of bumper 200.

The assembly of wheelbarrow 100 and the securing of bumper 200 to the wheelbarrow 100 will now be discussed by way of example. Bumper 200 is aligned with the ultimate distal ends of handles 120, 130. The distal ends 122, 132 of handles 120, 130 are inserted into sleeves 220, 230. The insertion of handles 120, 130 into sleeves 220, 230 causes pins 120A, 130A to retract into handles 120, 130. The distal ends of handles 120, 130 are further inserted into handles 120, 130 until holes 226, 236 are aligned with pins 120A, 130A such that pins 120A, 130A protrude through the holes 226, 236. This informs the person assembling the wheelbarrow that the distal ends of handles 120, 130 are sufficiently inserted into sleeves 220, 230. The locking of pins 120A 130A into the holes 226, 236 also prevents movement of the bumper on the handle ends and prevents the bumper from inadvertent removal from the wheelbarrow. In order to protect bumper body 211 and handles 120, 130 from extreme impact, wedges 320, 330 are inserted into gaps 227, 237. These wedges can be inserted before or after the handles are inserted into the sleeves. The assembly to this point provides handles 120, 130 with a non-parallel orientation that diverge as they extend in the proximal direction away from bumper body 211. The wheelbarrow 100 is then further assembled by securing the mid-point of handles 120, 130 to stand 102. If handles 120, 130 do not adequately align with their respective mounting positions on stand 102, then the orientation of sleeves 220, 230 are manipulated such that handles 120, 130 are able to be mounted to stand 102. The tub is secured to the handles 120, 130 above the stand 102. A tire 104 is coupled to handles 120, 130 towards the distal ends 122, 132 of handles 120, 130.

The benefit of bumper 200 is that it enables a bumper to be secured to wheelbarrow handles without the need for using nuts and bolts to secure the bumper 200 to the handles 120, 130. This improves the efficiency in assembling the overall wheelbarrow and simplifies the process. Bumper 200 also enables the person assembling the wheelbarrow to know when the handles 120, 130 are sufficiently inserted into the sleeves. Further, bumper 200 enables the person assembling the wheelbarrow to adjust the alignment of the sleeves 220, 230 in the event that the sleeves 220, 230 are not sufficiently aligned with the handles 120, 130.

In the preferred embodiment, bumper 200 is fabricated from steel. However, the bumper 200 could also benefit from the use of light weight or durable materials, including other metal alloys, composites, or hard plastics.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A wheelbarrow bumper for a wheelbarrow, comprising:
a bumper plate that spans distal ends of a plurality of wheelbarrow handles; and
a plurality of sleeves, each comprising a cavity for receipt of a distal end of a wheelbarrow handle, that are coupled to the bumper plate;
the plurality of sleeves extending in a direction relative to the bumper plate such that the sleeves comprise an angle of orientation that is non-perpendicular relative to the bumper plate, and such that upon insertion of the plurality of wheelbarrow handles into a corresponding sleeve and coupling of the plurality of wheelbarrow handles to at least one other wheelbarrow element, such as a wheelbarrow stand, tub, or tire, the plurality of sleeves are inhibited from moving in a proximal or distal direction relative to the wheelbarrow.

2. The wheelbarrow bumper of claim 1, wherein the angle of orientations of the plurality of sleeves are such that the sleeves are divergent.

3. The wheelbarrow bumper of claim 1, wherein the plurality of sleeves each comprise at least three walls that come into contact with at least three sides of a respective wheelbarrow handle.

4. The wheelbarrow bumper of claim 1, wherein the plurality of sleeves comprise left and right sleeves that are coupled to left and right ends of the bumper plate respectfully.

5. The wheelbarrow bumper of claim 4, wherein the left and right sleeves each comprise inner walls and outer walls such that the inner wall of the left sleeve opposes the inner wall of the right sleeve.

6. The wheelbarrow bumper of claim 5, wherein the inner wall of the left sleeve and the inner wall of the right sleeve are separated from one another such that the spacing of the inner walls increases in the proximal direction.

7. The wheelbarrow bumper of claim 6, wherein upon insertion of a left wheelbarrow handle into the left sleeve and a right wheelbarrow handle into the right sleeve and upon coupling the wheelbarrow handles to at least one other wheelbarrow element, the inner walls of the sleeves inhibit the wheelbarrow bumper from moving in the distal direction or the outer walls of the sleeves inhibit the wheelbarrow bumper from moving in the proximal direction.

8. The wheelbarrow bumper of claim 7, wherein the inner and outer walls of the sleeves comprise inner surfaces that form the cavities of the sleeves and come into contact with outer surfaces of the handles.

9. The wheelbarrow bumper of claim 8, wherein the inner surfaces of the sleeves are parallel to the outer surfaces of the handles.

10. The wheelbarrow bumper of claim 1, wherein the cavities of the sleeves are formed by inner surfaces of the sleeves and the inner surfaces provide sufficient contact area so as to secure the wheelbarrow bumper to the plurality of handles.

11. The wheelbarrow bumper of claim 1, wherein a gap is disposed between a portion of a sleeve that is disposed about an inner face of the bumper plate.

12. The wheelbarrow bumper of claim 11, wherein the gap is disposed between all portions of the sleeve that is disposed about the inner face of the bumper plate.

13. The wheelbarrow bumper of claim 11, wherein the gap comprises an acute angle formed between the distal end of the sleeve and the inner face of the bumper plate.

14. The wheelbarrow bumper of claim 11, further comprising at least one wedge that is disposed within the gap between the sleeve and the bumper plate.

15. The wheelbarrow bumper of claim 14, wherein the wedge comprises a surface that comes into contact with the bumper plate and an impact surface that comes into contact with a wheelbarrow handle.

16. The wheelbarrow bumper of claim 15, wherein the impact surface extends into the cavity of a sleeve.

17. The wheelbarrow bumper of claim 14, wherein the wedge is shaped so as to comprise an acute angle that corresponds to an acute angle of the gap formed between the distal end of the sleeve and the inner face of the bumper plate.

18. The wheelbarrow bumper of claim 14, wherein the wedge is an insertable part.

19. The wheelbarrow bumper of claim 1, wherein the bumper plate comprises a plurality of tabs that extend from the bumper plate towards the proximal direction of a wheelbarrow.

20. The wheelbarrow bumper of claim 19, wherein the bumper plate and plurality of tabs are of unibody construction.

21. The wheelbarrow bumper of claim 19, wherein the plurality of tabs are divergent in the direction of extension.

22. The wheelbarrow bumper of claim 19, wherein the plurality of sleeves are coupled to the plurality of tabs.

23. The wheelbarrow bumper of claim 1, wherein a sleeve comprises a slit that extends from an outer surface to an inner surface of a wall of the sleeve.

24. The wheelbarrow bumper of claim 23, wherein the slit extends over the entire length of the wall of the sleeve so as to bifurcate the wall.

25. The wheelbarrow bumper of claim 1, wherein a sleeve comprises an indicator for whether the handle is sufficiently inserted into the sleeve.

26. The wheelbarrow bumper of claim 25, wherein the indicator is a hole formed on a surface of the sleeve.

27. The wheelbarrow bumper of claim 26, wherein the hole extends from an outer surface of the sleeve to an inner surface of the sleeve.

28. The wheelbarrow bumper of claim 25, wherein the hole is sized to receive a pin.

29. The wheelbarrow bumper of claim 28, wherein the pin is coupled to the distal end of a wheelbarrow handle.

30. The wheelbarrow bumper of claim 29, wherein the pin retracts into the handle upon contact with an inner surface of the sleeve and extends through the hole upon alignment of the hole with the pin.

31. The wheelbarrow bumper of claim 1, wherein the wheelbarrow bumper is able to support the distal ends of the wheelbarrow handles so as to reduce deformation of the wheelbarrow handles due to dumping a wheelbarrow load.

32. A wheelbarrow, comprising:
left and right handles coupled to a stand and a tub, such that the handles are non-parallel; and
a tire coupled towards the distal end of the handles between the stand and a bumper;
the bumper coupled to the handles by receiving the distal ends of the handles in cavities of left and right sleeves that are coupled to tabs extending divergently from a bumper plate in a proximal direction.

33. A wheelbarrow, comprising:
a wheelbarrow bumper with a bumper plate that is coupled to a plurality of sleeves, each comprising a cavity that receives a distal end of a wheelbarrow handle;
wherein the sleeves are geometrically oriented so as to prevent the wheelbarrow bumper from falling off.

34. A wheelbarrow bumper for a wheelbarrow, comprising:
a bumper plate; and
a plurality of sleeves coupled to the bumper plate;
wherein the bumper plate and the at least one sleeve maintain contact with distal ends and sides of a plurality of handles so as to prevent deformation of the plurality of handles so as to prevent deformation of the handles, to cushion the handles against blows, and to dissipate impacts against the handles.

35. A wheelbarrow bumper for a wheelbarrow, comprising:
a bumper plate that spans distal ends of a plurality of wheelbarrow handles; and
a plurality of sleeves each extending in a direction relative to the bumper plate such that each sleeve comprises an angle of orientation that is non-perpendicular relative to the bumper plate and comprises at least one coupling surface that is parallel to each respective direction of extension and comes into contact with at least one corresponding surface of each corresponding distal end of the plurality of wheelbarrow handles, such that upon contacting each coupling surface with the corresponding surface of the plurality of wheelbarrow handles, and coupling of the plurality of wheelbarrow handles to at least one other wheelbarrow element, such as a wheelbarrow stand, tub, or tire, the plurality of sleeves are inhibited from moving in a proximal or distal direction relative to the wheelbarrow.

36. The wheelbarrow bumper of claim 35, wherein each of the distal ends of the wheelbarrow handles comprise a cavity for receipt of a sleeve.

37. The wheelbarrow bumper of claim 36, wherein each coupling surface is contacted with the corresponding surface of the plurality of wheelbarrow handles upon insertion of the plurality of sleeves into a corresponding wheelbarrow handle.

38. The wheelbarrow bumper of claim 37, wherein each coupling surface is an outer surface of each respective sleeve that contacts a corresponding inner surface of a wheelbarrow handle.

39. The wheelbarrow bumper of claim 38, wherein the plurality of sleeves each comprise at least two walls that come into contact with at least two inner surfaces of a respective wheelbarrow handle.

40. The wheelbarrow bumper of claim 39, wherein the inner surfaces of the wheelbarrow handles form the cavities of the wheelbarrow handles.

41. The wheelbarrow bumper of claim 40, wherein the inner surfaces of the wheelbarrow handles are parallel to the outer surfaces of the sleeves.

42. The wheelbarrow bumper of claim 38, wherein a wheelbarrow handle comprises an indicator for whether the sleeve is sufficiently inserted into the handle.

43. The wheelbarrow bumper of claim 42, wherein the indicator is a hole that extends from an outer surface of the handle to an inner surface of the handle and that is sized to receive a spring loaded pin coupled to the contact surface of the sleeve.

44. The wheelbarrow bumper of claim 35, wherein each of the plurality of sleeves comprise a cavity for receipt of a distal end of a wheelbarrow handle.

45. The wheelbarrow bumper of claim 44, wherein each coupling surface is contacted with the corresponding surface of the plurality of wheelbarrow handles upon insertion of the plurality of wheelbarrow handles into a corresponding sleeve.
